(19) United States
(12) Patent Application Publication
(10) Pub. No.: US 2012/0272890 A1
(43) Pub. Date: Nov. 1, 2012

(54) ADAPTER TO ENABLE A FISHING ROD HOLDER TO BE COUPLED TO A DOWNRIGGER MOUNTING PLATE TO ENABLE THE DOWNRIGGER MOUNTING PLATE TO BE USED FOR NON-DOWNRIGGED FISHING

(76) Inventor: Kevin Henke, Port Angeles, WA (US)

(21) Appl. No.: 13/094,767

(22) Filed: Apr. 26, 2011

(51) Int. Cl. B63B 17/00; B23P 23/00

(52) U.S. Cl. 114/364; 29/401.1

(57) ABSTRACT

An adapter plate enables a fishing rod holder bracket to be attached to a downrigger mounting plate, enabling the downrigger mounting plate to be used as a fishing rod support for non-downrigged fishing. In at least one embodiment, the adapter plate includes a shelf that extends beyond a boundary of the downrigger mounting plate, the shelf enabling an electric rod motor to be supported. In at least one embodiment, a threaded rod engages the shelf and the electric rod motor, enabling the elected rod motor to be supportingly spaced apart from the shelf.

### BACKGROUND

A downrigger is a type of fishing gear used while fishing with the trolling technique, which places a lure at a desired depth. A downrigger generally includes a mounting base which is attached to a fishing boat, a horizontal boom or pole (ranging from about three to about six feet), a cannonball (i.e., a relatively large weight), a steel cable (one end of which is attached to the pole, the other end of which is attached to the cannonball), and a spool holding the cable. A clip or release is used to attach a fishing line (from a conventional fishing rod) to the cannonball weight. The bait or lure is attached to the release or the end of the fishing line. When a fish bites, the clip disengages the fishing line, and the fisherman can land the fish. The weight is normally a five-to-twenty-pound lead mass. A manual crank (a manual downrigger) or electric motor (an electric downrigger) is used to retrieve the weight.

Downriggers are well suited to fishing during certain fishing runs, but in general downriggers will not be used year-round, or at the very least are not useful for all types of fishing. When not in use, the weight, cable, boom, and spool will generally be removed from the fishing boat. The mounting base (referred to as a tower by some downrigger vendors) is often left in place. Because space on a fishing boat is often at a premium, the space allocated to the downrigger mounting base represents an undesirable loss of space when the downrigger is not being used. It would be desirable to provide techniques for utilizing the downrigger mounting base or tower, even when the downrigger weight, cable, boom, and spool are not in use.

### SUMMARY

This application specifically incorporates by reference the disclosures and drawings of each patent application and issued patent identified above as a related application.

The concepts disclosed herein enable a downrigger mounting plate (often left in place on a fishing boat when the spool, boom, weight and cable portions of a downrigger system are removed from the fishing boat) to be used to support a fishing pole for non-downrigged fishing.

In at least one embodiment of the concepts disclosed herein, an adapter plate is provided for attaching a fishing rod holder bracket to a downrigger mounting plate, enabling the downrigger mounting plate to be used as a fishing rod support for non-downrigged fishing. Adapter plates are specifically configured to be used with down rigger mounting brackets and fishing rod holder brackets provided by various fishing equipment vendors. Such an adapter plate includes a first set of openings configured to align with existing openings on the downrigger mounting plate (the first set of openings enabling the adapter plate to be removably attached to the downrigger mounting plate), and a second set of openings configured to align with existing openings on the fishing rod holder bracket (the second set of openings enabling the fishing rod holder bracket to be removably attached to the adapter plate). In at least one embodiment, the first set of openings pass completely through the adapter plate, while the second set of openings do not pass completely through the adapter plate.

In a related adapter plate embodiment, the adapter plate includes an upper surface having four corners defining a parallelogram, with one of the first openings being disposed in each corner. The second openings are disposed inwardly of the first openings.

In a related adapter plate embodiment, each second opening includes a threaded insert configured to receive a threaded fastener used to secure the fishing rod holder bracket to the adapter plate.

In a related adapter plate embodiment, each first opening includes a first portion and a second portion, the first portion being relatively larger in diameter than the second portion, the first portion being in contact with an upper surface of the adapter plate, the first portion enabling a fastener inserted into each first opening to sit flush with the upper surface.

In a related adapter plate embodiment, the adapter plate includes an upper surface having four corners defining a parallelogram, with a shelf extending away from one side of parallelogram, the shelf providing support for an electric motor to be used with a fishing rod placed in the fishing rod holder bracket. In at least one embodiment, the shelf is generally triangular in shape, a base of the triangle converging with one of the sides of the parallelogram. In at least one embodiment, the shelf extends beyond the downrigger mounting plate, and includes an opening configured to engage a threaded rod used to support the electric motor.

In a related adapter plate embodiment, at least one of the following is true: the adapter plate is made from a polymeric material, the adapter plate includes four first openings, the adapter plate includes four second openings, and the adapter plate is sized and shaped to cover the entire upper surface of the downrigger mounting plate when the adapter plate is secured to the downrigger mounting plate.

In a related adapter plate embodiment, the adapter plate includes at least one additional opening, the additional opening configured to accommodate retaining hardware used to secure the fishing rod to the adapter plate. In at least one embodiment, the retaining hardware includes an eyebolt threaded into the at least one additional opening.

Yet another aspect of the concepts disclosed herein is a kit for attaching a fishing rod holder bracket to a downrigger mounting plate, the kit enabling the downrigger mounting plate to be used as a fishing rod support for non-downrigged fishing. In an exemplary embodiment, the kit includes an adapter plate to be attached to a downrigger mounting plate, first fasteners to attach the adapter plate to the downrigger mounting plate, and second fasteners to attach the fishing rod support bracket to the adapter plate. In an exemplary embodiment, the adapter plate includes a first set of openings configured to align with existing openings on the downrigger mounting plate (the first set of openings enabling the adapter plate to be removably attached to the downrigger mounting plate), and a second set of openings configured to align with existing openings on the fishing rod holder bracket (the second set of openings enabling the fishing rod holder bracket to be removably attached to the adapter plate). In at least one embodiment, the first set of openings pass completely through the adapter plate, while the second set of openings do not pass completely through the adapter plate.

In a related kit embodiment, each first fastener includes a threaded shaft and a threaded retainer, and each second fastener includes a threaded shaft.

In a related kit embodiment, the kit further includes the fishing rod bracket holder.

In a related kit embodiment, the adapter plate in the kit includes an upper surface having four corners defining a parallelogram, with a shelf extending away from one side of the parallelogram, the shelf providing support for an electric motor to be used with a fishing rod placed in the fishing rod holder bracket. In at least one embodiment, the adapter plate shelf includes an opening configured to engage a threaded rod used to support the electric motor, and the kit includes the threaded rod. In at least one embodiment, the kit includes a threaded rod having a distal planar surface configured to engagingly support the electric motor.

In a related kit embodiment, the adapter plate in the kit includes at least one additional opening, the additional opening being configured to accommodate retaining hardware used to secure the fishing rod to the adapter plate. In such an embodiment, the kit can include the retaining hardware, a portion of which is threaded into the at least one additional opening. Exemplary retaining hardware includes an eyebolt threaded into at least one additional opening, with a cable or line that is tied to the fishing rod. A quick release fastener may be used to enable the fishing rod to be easily released from the retaining hardware.

The concepts disclosed herein also encompass a method for enabling a downrigger mounting plate to be used as a fishing rod support for non-downrigged fishing. An exemplary method includes the steps of attaching an adapter plate to a downrigger mounting plate, in place of the downrigger spool and boom structure normally attached to the downrigger mounting plate, and attaching a fishing rod support bracket to the adapter plate, thereby enabling the downrigger mounting plate to be used as a fishing rod support for non-trolling fishing.

In a related method, the adapter plate attached to the downrigger mounting plate includes a first set of openings configured to align with existing openings on the downrigger mounting plate (the first set of openings enabling the adapter plate to be removably attached to the downrigger mounting plate), and a second set of openings configured to align with existing openings on the fishing rod holder bracket (the second set of openings enabling the fishing rod holder bracket to be removably attached to the adapter plate). In at least one embodiment, the first set of openings pass completely through the adapter plate, while the second set of openings do not pass completely through the adapter plate.

In a related method, the adapter plate attached to the downrigger mounting plate includes a shelf extending beyond the downrigger mounting plate, the shelf providing support for an electric motor to be used with a fishing rod placed in the fishing rod holder bracket. In at least one embodiment, the method includes the step of inserting a threaded rod into an opening in the shelf, the threaded rod having a planar surface on its distal end, and adjusting a height of the threaded rod such that the planar surface provides support to the electric motor.

In a related method, retaining hardware is employed to secure the fishing rod to the adapter plate, to prevent loss of the fishing pole during an accident, due to a rogue wave, or inclement weather.

This Summary has been provided to introduce a few concepts in a simplified form that are further described in detail below in the Description. However, this Summary is not intended to identify key or essential features of the claimed subject matter, nor is it intended to be used as an aid in determining the scope of the claimed subject matter.

### DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIGS. 1-6 schematically illustrate various components relating to a popular prior art downrigger system;

FIG. 7 schematically illustrates a popular prior art fishing rod support bracket not intended for use with a downrigger system;

FIG. 8 schematically illustrates an adapter enabling a fishing rod support bracket to be attached to a downrigger mounting plate, enabling the downrigger mounting plate to be used for non-downrigged fishing;

FIG. 9 schematically illustrates the adapter of FIG. 8 being used to attach a fishing rod support bracket to a downrigger mounting plate, while also supporting an electric rod motor;

FIG. 10 schematically illustrates an exemplary kit for enabling a fishing rod support bracket to be attached to a downrigger mounting plate, enabling the downrigger mounting plate to be used for non-downrigged fishing;

FIG. 11 schematically illustrates exemplary steps in a method for enabling a fishing rod support bracket to be attached to a downrigger mounting plate, enabling the downrigger mounting plate to be used for non-downrigged fishing;

FIG. 12 is a production drawing including plan and side elevational views of a first adapter intended to be used for a specific downrigger mounting plate and fishing rod support bracket;

FIG. 13 is a production drawing including plan and side elevational views of a second adapter intended to be used for a specific downrigger mounting plate and fishing rod support bracket;

FIG. 14 is a production drawing including plan and side elevational views of a third adapter intended to be used for a specific downrigger mounting plate and fishing rod support bracket, the third adapter including a shelf for supporting an electric rod motor;

FIG. 15 is a production drawing including plan and side elevational views of a fourth adapter intended to be used for a specific downrigger mounting plate and fishing rod support bracket, the fourth adapter including a shelf for supporting an electric rod motor; and

FIG. 16 schematically illustrates an additional exemplary kit for enabling a fishing rod support bracket to be attached to a downrigger mounting plate, enabling the downrigger mounting plate to be used for non-downrigged fishing.

### DESCRIPTION

### Figures and Disclosed Embodiments are not Limiting

Exemplary embodiments are illustrated in referenced Figures of the drawings. It is intended that the embodiments and Figures disclosed herein are to be considered illustrative rather than restrictive. No limitation on the scope of the technology and of the claims that follow is to be imputed to the examples shown in the drawings and discussed herein. Further, it should be understood that any feature of one embodiment disclosed herein can be combined with one or more features of any other embodiment that is disclosed, unless otherwise indicated.

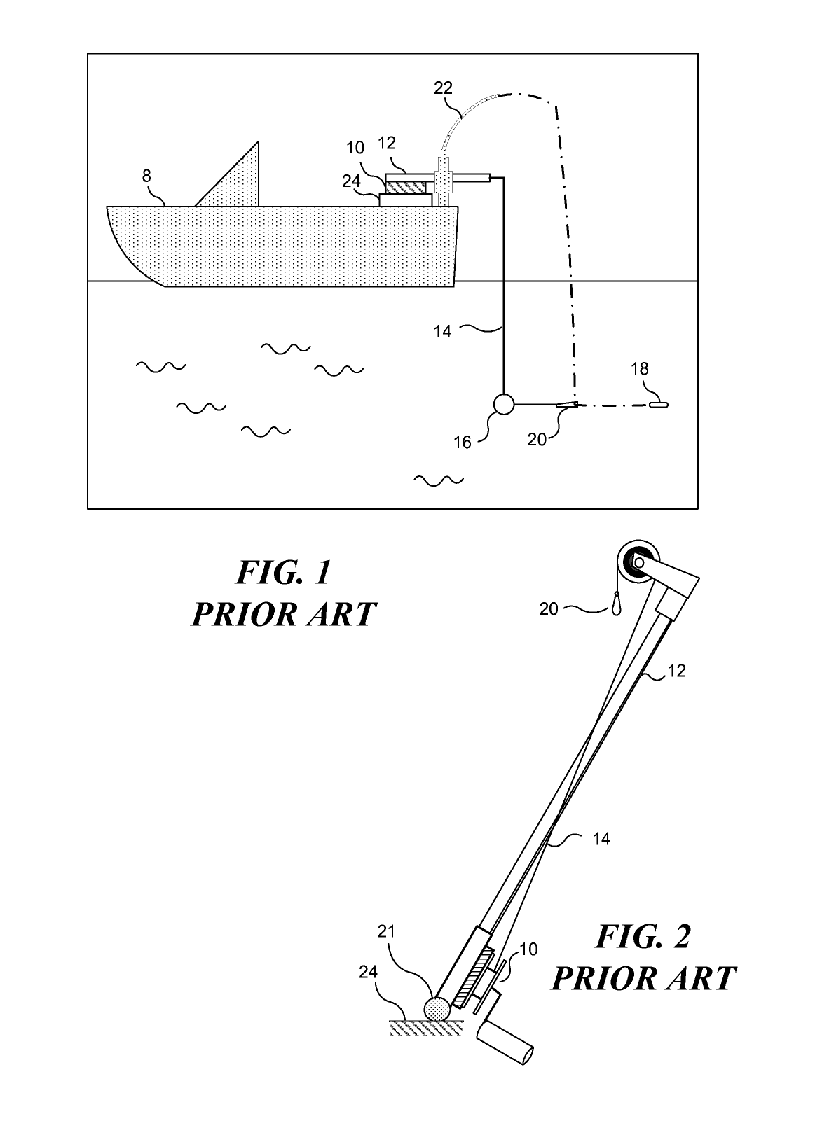

FIGS. 1-6 schematically illustrate various components relating to a popular prior art downrigger system, provided by Scotty Fishing and Marine Products (Sydney, B.C., Canada). Other fishing equipment vendors provide similar downrigger systems.

FIG. 1 schematically illustrates the basic downrigger fishing concept. A downrigger system including a spool 10 and a boom 12 is attached to a fishing boat 8. A weight 16 is deployed from the downrigger system using a cable 14. The amount of cable deployed will control the depth of the weight, enabling the fisherman to troll at a desired depth (which may be different when fishing for different species or in different locations). Depth finders, fish finders, fishing charts, historical records and other equipment can be used to determine the optimal depth. A lure 18 from a fishing pole 22 (which may be attached to boom 12, or to another location on the fishing boat) is kept at the depth of weight 16 by a release 20 attached to the weight. When a fish bites on lure 18, the tension actuates release 20, and the line from the fishing pole is no longer restrained by release 20, and the fisherman is free to reel in the line to land the fish. A manual winch or electric winch is used to recover the weight, and the system can be reset for further trolling at the desired depth. The downrigger system is attached to fishing boat 8 using a downrigger mounting plate 24.

FIG. 2 schematically illustrates a downrigger system in a stored position (whereas FIG. 1 shows the downrigger system in a deployed position). A pivoting bracket 21 enables boom 12 to move from a generally horizontal position in FIG. 1 to a vertical position in FIG. 2. In this stored position of FIG. 2, the fisherman has good access to release 20, and can easily load the weight and engage the fishing line from the fishing pole to release 20.

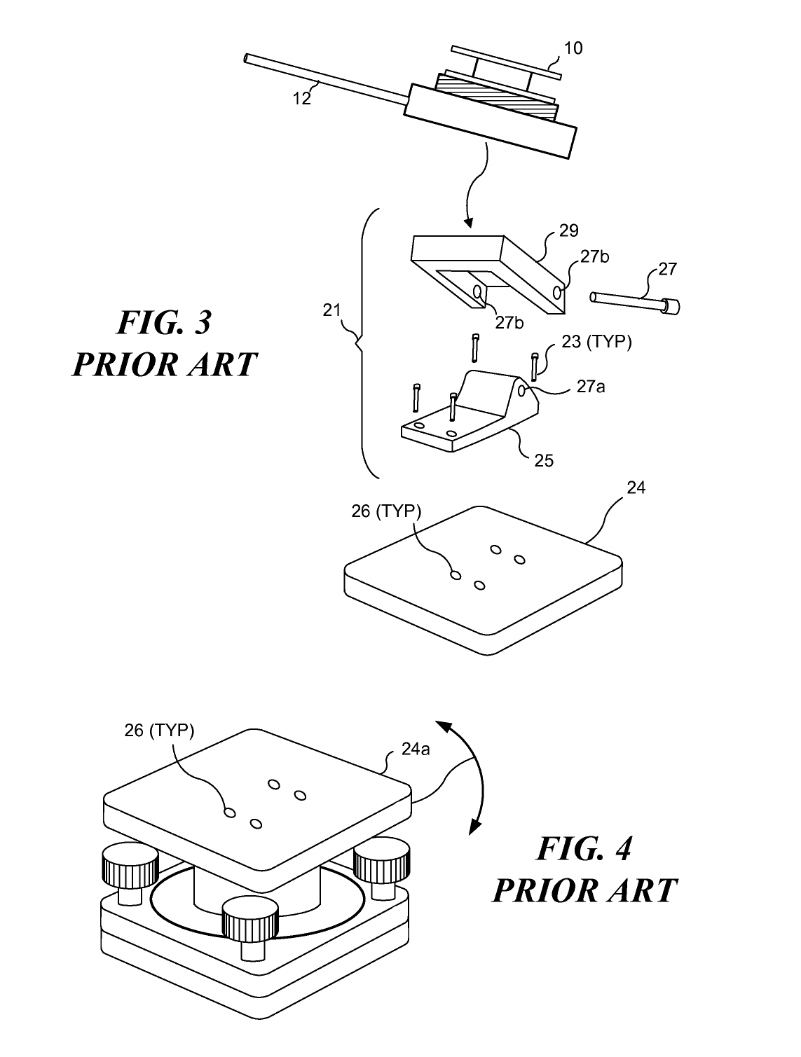

FIG. 3 schematically illustrates an exemplary pivoting bracket 21 (used by Scotty Fishing and Marine Products) that enables spool 10 and boom 12 to move from the generally horizontal position in FIG. 1 to the generally vertical position in FIG. 2. Note that the spool and boom can be readily removed from pivoting bracket 21, such that when not in use, the spool, cable, boom, and weight can be removed from the pivoting bracket and stored. Pivoting bracket 21 includes a lower element 25 and an upper element 29, which are removably coupled together using a shaft 27. Shaft 27 passes through openings 27a in lower element 25 and openings 27b in upper element 29. Spool 10 and boom 12 are generally permanently attached to upper element 29, such that the shaft, the upper element, the spool, the cable, the weight, and the release (see FIG. 1) can be stored when not in use, leaving only lower element 25 attached to the boat (if desired, lower element 25 can also be removed from the downrigger mounting plate when the downrigger system is not in use). The lower element is attached to a substrate using fasteners 23. In some embodiments, lower element 25 of pivoting bracket 21 could be mounted directly to the boat. However, lower element 25 of pivoting bracket 21 is often secured to a downrigger mounting plate (again using fasteners 23). In some embodiments, the downrigger mounting plate has hardware to facilitate attaching the downrigger mounting plate to the fishing boat. In some embodiments, downrigger mounting plate is attached to a movable support structure (referred to as a tower) that provides the ability to move the spool and boom elements when they are attached to the tower. The pivoting bracket itself is then attached to whatever downrigger mounting plate (i.e., a fixed plate or a movable plate) the fisherman has chosen to employ.

FIG. 4 schematically illustrates a tower that provides some ability to move the spool and boom elements when they are attached to the tower. The upper surface of the tower is a downrigger mounting plate 24a, which includes openings 26 to receive fasteners 23 (see FIG. 2) to enable pivoting bracket 21 to be attached to the downrigger mounting plate. The tower includes elements that enable the fisherman to selectively rotate downrigger mounting plate 24a. The use of the adapters disclosed herein is particular beneficial when the downrigger mounting plate is movable. When the adapter is used to attach a fishing rod holder to a movable downrigger mounting plate (such as the downrigger plate in FIG. 4), the fisherman can change the position of the fishing pole while the pole is supported by the fishing rod bracket attached to the adapter. In an exemplary embodiment, the adapter is used with a movable downrigger mounting plate. The tower embodiment, providing a movable downrigger mounting plate, is often referred to as a swivel base or swivel mount. For example, Scotty Fishing and Marine Products offers the Scotty 1026 Pedestal Swivel Mount™, which can be rotated 360 degrees.

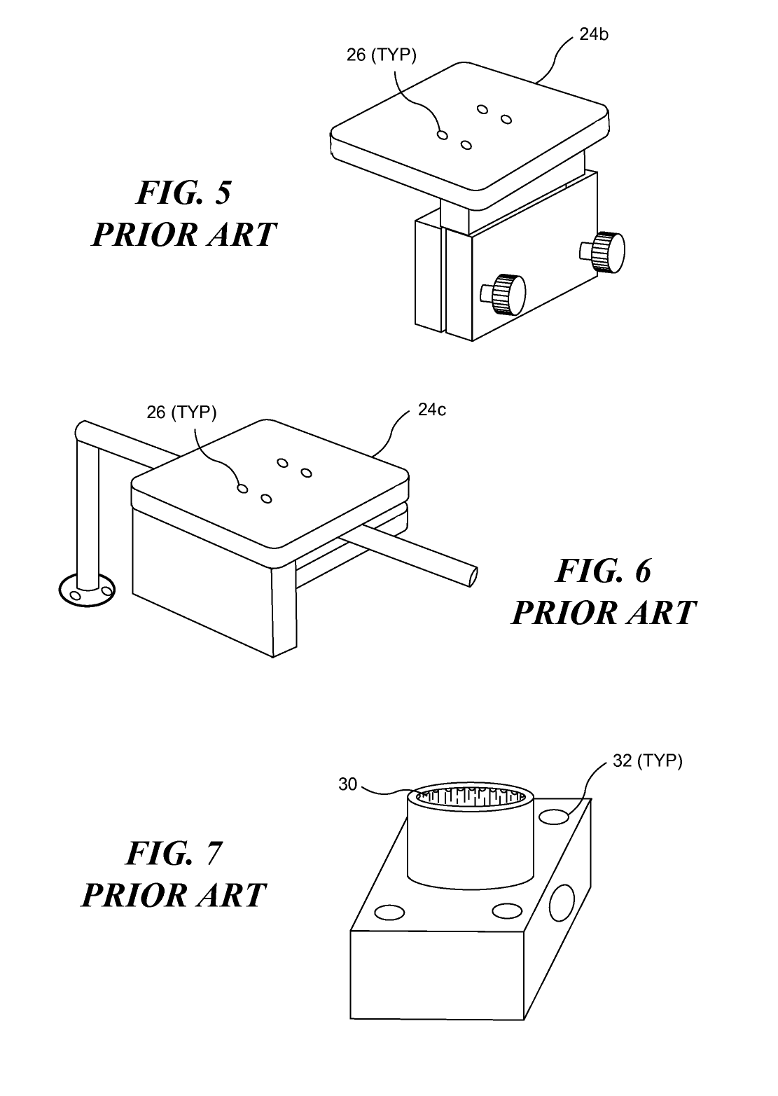

FIG. 5 schematically illustrates a bracket assembly that enables a downrigger mounting plate 24b to be attached to a fishing boat. Again, downrigger mounting plate 24b includes openings 26 to receive fasteners 23 (see FIG. 2) to enable pivoting bracket 21 to be attached to the downrigger mounting plate.

FIG. 6 schematically illustrates another bracket assembly that enables a downrigger mounting plate 24c to be attached to a fishing boat. Again, downrigger mounting plate 24c includes openings 26 to receive fasteners 23 (see FIG. 2) to enable pivoting bracket 21 to be attached to the downrigger mounting plate.

Note that each downrigger mounting plate in FIGS. 4, 5, and 6 is configured to support the same pivoting bracket 21, so that the pivoting bracket need not be attached directly to the boat. The base plate for the tower shown in FIG. 4 is generally secured to a vessel once, while the downrigger plates shown in FIGS. 5 and 6 can be more readily removed from a fishing vessel. When the downrigger system is not in use, the spool, boom, weight and cable components are stored. Particularly with respect to the downrigger mounting plate of FIG. 4 (or the downrigger mounting plates of FIGS. 5 and 6, if left in place on a boat), when the spool, boom, weight and cable components are stored, the downrigger mounting plate then serves no useful function, and takes up a finite amount in a generally small fishing boat. The concepts disclosed herein relate to enabling the downrigger mounting plate (regardless of the specific design) to serve a useful purpose even when the fisherman is not using the downrigger system itself. The concepts disclosed herein encompass an adapter plate to enable a fishing rod support bracket to be removably attached to the downrigger mounting plate.

FIG. 7 schematically illustrates a popular fishing rod support bracket that includes a central opening 30 to receive a butt end of a fishing rod, and a plurality of openings 32 to engage fasteners (not shown) to attach the fishing rod support bracket to a fishing boat. Significantly, the pattern of fastener openings in pivoting bracket 21 (or similar components offered by other downrigger system vendors) does not correspond to the fasteners openings in available fishing rod support brackets, so one can't simply attach a fishing rod support bracket to a downrigger mounting plate just by removing the pivoting bracket. While the concepts disclosed herein focus on an adapter plate that can be used to enable existing fishing rod support brackets to be used with existing downrigger mounting plates, the concepts disclosed herein also encompass a fishing rod support bracket whose mounting holes align with those present on existing downrigger mounting plates. This could be implemented by producing a new mold for a fishing rod support bracket, or physically modifying existing fishing rod support brackets whose existing mounting holes do not align with existing openings in downrigger mounting plates, to provide new openings that do align with existing openings in downrigger mounting plates. Referring to FIGS. 3, 4, 5, and 6, a plurality of different downrigger mounting plates provided by Scotty Fishing and Marine Products are schematically illustrated. Each downrigger mounting plate includes openings 26 configured to receive fasteners 23 to enable lower element 25 of pivoting bracket 21 (see FIG. 3) to be attached to each of the downrigger mounting plates. The fishing rod support bracket of FIG. 7 could be modified to include openings 32 arranged to correspond to openings 26 in the downrigger mounting plates in FIGS. 3, 4, 5, and 6. Thus, the concepts disclosed herein further encompass a fishing rod support bracket including openings that align with existing openings in a downrigger mounting plates, so the fishing rod support bracket can be attached directly to an existing downrigger mounting plate, without using one of the adapters disclosed herein.

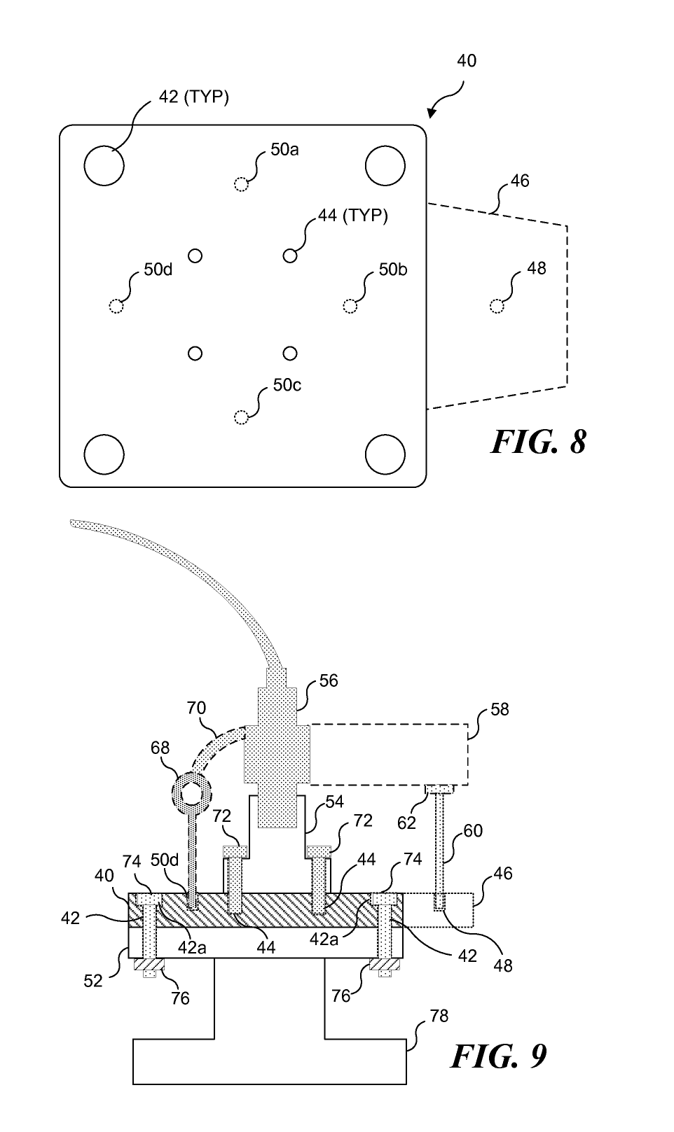

FIG. 8 schematically illustrates an adapter 40 enabling a fishing rod support bracket, such as the one shown in FIG. 7, to be attached to a downrigger mounting plate, enabling the downrigger mounting plate to be used for non-downrigged fishing. Adapter 40 includes a plurality of first openings 42, and a plurality of second openings 44. It should be recognized that the relative positions and orientation of these openings will be a function of the specific fishing rod holder bracket and downrigger mounting plate with which the adapter will be used (noting that downrigger mounting brackets and fishing rod holder brackets provided by various fishing equipment vendors will require the openings to be positioned differently). To use adapter 40 with pivoting bracket 21 of FIG. 3, lower element 25 is generally first removed and stored. If desired, adapter 40 could be made thick enough, and include a surface feature on the lower side of the adapter, such that adapter 40 could be mounted over the lower element of the pivoting bracket. In at least some embodiments, adapter 40 has a generally planar lower surface, and is intended to be employed after the pivoting bracket (including lower element 25 of FIG. 3) is removed from the downrigger mounting plate.

Adapter 40 includes a first set of openings 42 configured to align with existing openings on the downrigger mounting plate (the first set of openings enabling the adapter plate to be removably attached to the downrigger mounting plate), and a second set of openings 44 configured to align with existing openings on the fishing rod holder bracket (the second set of openings enabling the fishing rod holder bracket to be removably attached to the adapter plate). In at least one embodiment, the first set of openings pass completely through the adapter plate, while the second set of openings do not pass completely through the adapter plate. Many downrigger mounting plates, particular those provided by Scotty Fishing and Marine Products, include openings that can be used to receive fasteners inserted into openings 42 on adapter 40. If a particular downrigger mounting plate does not include openings that align with openings 42 on adapter 40, the user of adapter 40 can drill such openings in that downrigger mounting plate (as most such downrigger mounting plates are made from polymers, and end users will generally be able to drill holes into such downrigger mounting plates if required). Furthermore, the adapter plate will, in at least some embodiments, be made out of a polymeric or metallic material that can be modified by an end user, such that the end user could drill or otherwise machine openings to align with available openings on a downrigger mounting plate.

As shown in FIG. 8, adapter 40 (also referred to herein as the adapter plate, and adapter plate 40) has an upper surface defining a parallelogram (or square), with one of the first openings 42 being disposed in each corner. Second openings 44 are disposed inwardly of the first openings. In an exemplary, but not limiting embodiment, each second opening 44 includes a threaded insert configured to receive a threaded fastener used to secure the fishing rod holder bracket to the adapter plate. While four first openings and four second openings are shown, it should be understood that more or fewer openings of each type could be employed.

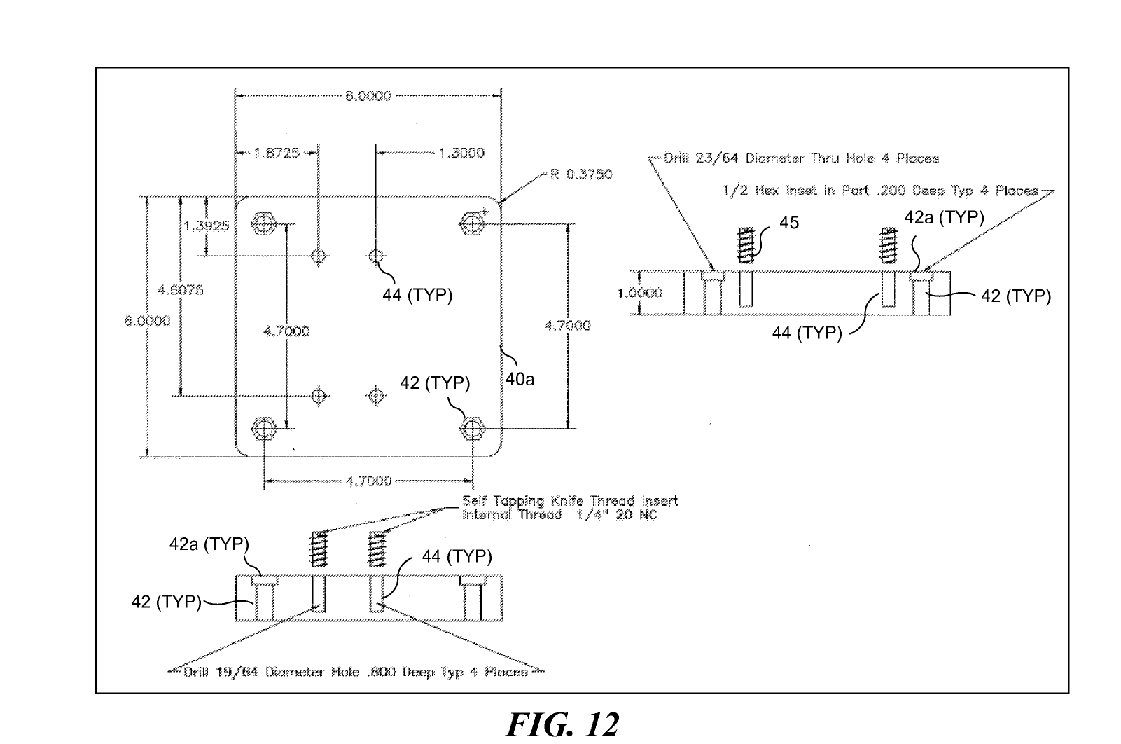

In an exemplary, but not limiting embodiment, each first opening includes a first portion and a second portion, the first portion being relatively larger in diameter than the second portion, the first portion being in contact with an upper surface of the adapter plate, the first portion enabling a fastener inserted into each first opening to sit flush with the upper surface. This concept is shown in FIGS. 12-15, discussed below. In an exemplary embodiment, the adapter is attached to the downrigger mounting plate using hex head fasteners, and the first portion of openings 42 is shaped and sized to receive the hex head, so that the fastener is locked in place (i.e., the fastener is not free to rotate, because the hex head engages the walls of the upper portion of the first openings). A lock nut (or standard nut and lock washer) is threaded onto a distal end of the fastener, after passing through the downrigger mounting plate, to secure the adapter to the downrigger mounting plate. Some downrigger mounting plates may include (or be modified to include) threaded inserts configured to receive threaded shafts, in which case the lock nut/standard nut would not be required. In an exemplary, but not limiting embodiment, wing nuts are used to secure the adapter plate to the downrigger mounting plate, such that the fisherman need not have access to hand tools to attach the adapter to the downrigger mounting plate.

In at least one exemplary embodiment, the adapter plate is sized and shaped to cover the entire upper surface of the downrigger mounting plate when the adapter plate is secured to the downrigger mounting plate.

In some embodiments, adapter plate 40 includes an optional shelf 46 that extends away from one side of parallelogram defining the upper surface of the adapter. Shelf 46 can be used to provide support for an electric motor to be used with a fishing rod placed in the fishing rod holder bracket (such motors are used by some fishermen in lieu of using a hand crank to manually reel in fishing line). As shown in FIG. 8, shelf 46 is generally triangular in shape (more properly, a truncated triangle), with a base of the triangle converging with one of the sides of the parallelogram. In at least one embodiment, the shelf extends beyond the downrigger mounting plate, and includes one or more openings 48 configured to engage a threaded rod used to support the electric fishing rod motor.

If desired, adapter plate 40 includes at least one additional opening (openings 50a-50d being exemplary of such additional openings) configured to accommodate retaining hardware used to secure the fishing rod to the adapter plate. In at least one embodiment, the retaining hardware includes an eyebolt threaded into the at least one additional opening. While only one such additional opening is required, it may be desirable to utilize a plurality of openings, to better accommodate right and left handed fishing reels. For example, where such a right hand/left hand issue arises, the user can select the appropriate one of opening 50a or 50c (or the appropriate one of opening 50b or 50d). Referring to opening 50d, note that opening 50d could similarly be used to support an electric fishing rod motor, if a similar right hand/left hand issue required the motor to be supported on a different side of the adapter plate.

FIG. 9 schematically illustrates adapter 40 of FIG. 8 being used to attach fishing rod support bracket 54 to a downrigger mounting plate 52, while optionally supporting an electric rod motor 58 attached to fishing rod 56. It should be recognized no attempt has been made to show individual components in scale; thus the sizes and shapes of individual components as indicated in the Figure is not intended to be limiting. For example, an actual fishing pole will likely be relatively larger than the fishing rod shown in the Figure, and the size of the electric fish rod motor as shown in the Figure is larger in scale that other elements in the Figure.

Downrigger mounting plate 52 is shown attached to a tower 78 (see FIG. 4); although it should be recognized that downrigger mounting plate 52 could be attached to other types of substrates. Adapter plate 40 has been attached to downrigger mounting plate 52 using fasteners 74 inserted into openings 42 in adapter plate 40 (and corresponding openings in downrigger mounting plate 52). Retaining nuts 76 (which in at least some embodiments are hand tightening wing nuts, while in other embodiments are self locking cap nuts, or hex nuts; noting that lock washers can be used along with the retaining nuts) are used to secure adapter plate 40 to downrigger mounting plate 52. As shown in FIG. 9, an upper portion 42a of openings 42 are sized and shaped to engage an upper portion of fasteners 74. While this is not strictly required, it is beneficial in that the fastener is locked in place (and cannot rotate), such that securing the fastener is simplified (no tool is required to secure the head of the fastener), and the upper portion of the fastener is flush with an upper surface of the adapter plate, and cannot become tangled with fishing line or other objects.

Fishing rod support bracket 54 is attached to adapter plate 40 using fasteners 72 inserted into openings 44 in adapter plate 40, and corresponding openings in fishing rod support bracket 54. It would be possible for fasteners 72 to pass completely through the adapter plate and downrigger mounting plate (as do fasteners 74), if desired, and if the configuration of the downrigger mounting plate accommodates such an orientation. In an exemplary embodiment, fasteners 72 can be secured using a screw driver or a hex wrench, minimizing the tools required to install the adapter plate and fishing rod support bracket 54. In at least one embodiment, each fastener 72 is a threaded rod, with no cap, and a wing nut is used to secure the fishing rod support bracket 54 to the threaded rod inserted into openings 44 in adapter plate 40 (in such an embodiment, where retaining nuts 76 are also wing nuts, no hand tools are required for installation of the adapter plate and fasteners).

Where optional shelf 46 is used to support electric fishing rod motor 58, a threaded rod 60 is inserted into opening 48 (which, as discussed above in connection with openings 44, in an exemplary embodiment includes a threaded insert to engage a distal end of threaded rod 60). In at least one embodiment, a distal end of threaded rod 60 includes a planar surface 62 to support the electric motor. The planar surface can be parallel to the upper surface of the adapter plate, or at an angle, as required to provide support to the motor. In some embodiments, a support including a curved surface (where the curve matches a curved surface of an electric rod motor) is employed in place of the planar surface.

In each embodiment where a threaded rod or fastener is employed, it should be understood that some portions of the rod/fastener may not include threads. For example, many fasteners and threaded rods include smooth shank portions in locations where threads are not required to engage threads in openings in which the fastener/rod is to be inserted.

Some users may desire to utilize restraining hardware to secure their fishing rod to the adapter plate, to prevent the rod from being lost overboard in case of an accident, a rogue wave, or inclement weather. As shown in FIG. 9, a threaded rod 68 (in this case, an eyebolt, recognizing that other types of threaded rods can be used) is inserted into an additional opening in adapter plate 40 (in this case, opening 50d), and a cable tie 70 (or some other type of restraint) is attached to threaded rod 68 and fishing rod 56. In some embodiments, the user may want to include a quick release fastener so that the restraining tie can quickly be released from fishing rod 56 or threaded rod 68, to enable the fishing rod to be released from the adapter plate.

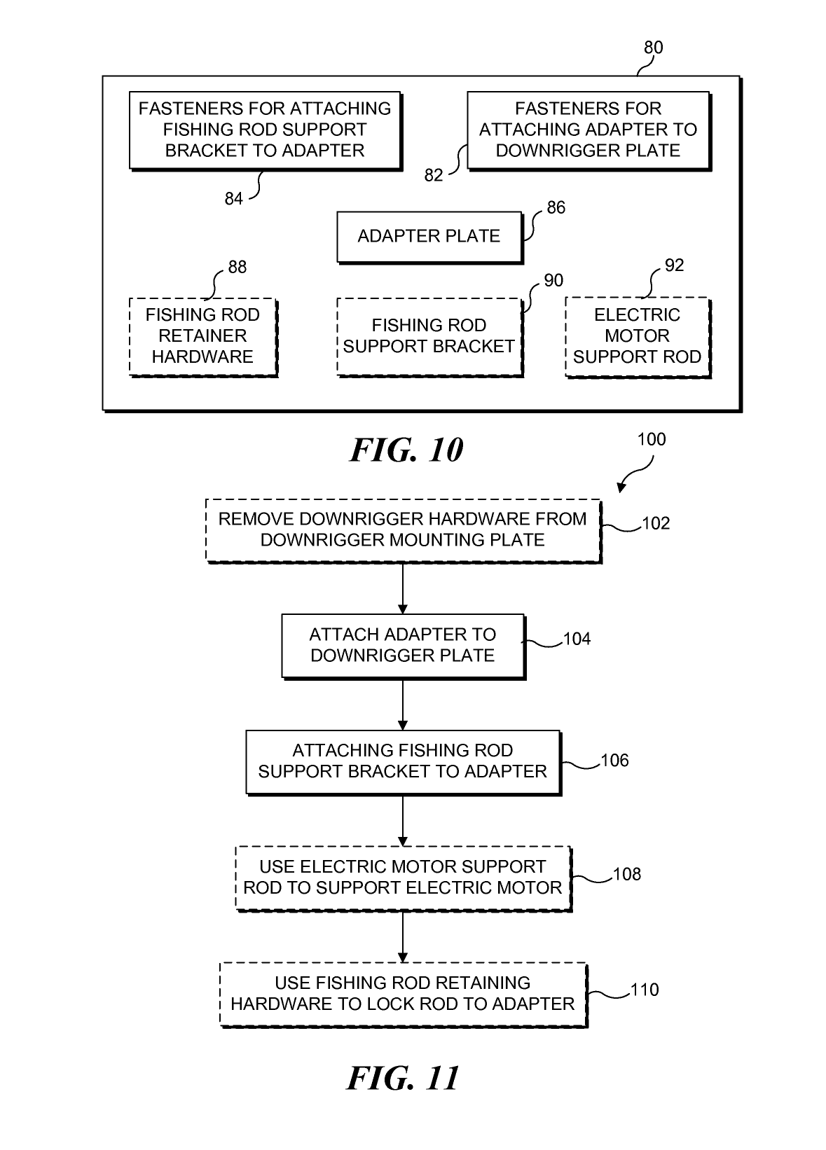

FIG. 10 schematically illustrates an exemplary kit 80 for enabling a fishing rod support bracket to be attached to a downrigger mounting plate, enabling the downrigger mounting plate to be used for non-downrigged fishing. Basic elements in kit 80 include an adapter plate 86, first fasteners 82 (for attaching the adapter plate to the downrigger mounting plate), and second fasteners 84 (for attaching the fishing rod support bracket to the adapter plate). Optional elements include fishing rod support bracket 90 (this is an optional element, because many fisherman already have several such brackets), fishing rod retainer hardware 88 (such as threaded rod 68, cable tie 70, and if desired a quick release fastener), and an electric rod motor support rod 92. The function of such optional elements has been generally described in connection with FIG. 9.

Such a kit (for attaching a fishing rod holder bracket to a downrigger mounting plate) enables the downrigger mounting plate to be used as a fishing rod support for non-downrigged fishing. As noted above, the kit minimally includes an adapter plate to be attached to a downrigger mounting plate, first fasteners to attach the adapter plate to the downrigger mounting plate, and second fasteners to attach the fishing rod support bracket to the adapter plate. In an exemplary embodiment, the adapter plate includes a first set of openings configured to align with existing openings on the downrigger mounting plate (the first set of openings enabling the adapter plate to be removably attached to the downrigger mounting plate), and a second set of openings configured to align with existing openings on the fishing rod holder bracket (the second set of openings enabling the fishing rod holder bracket to be removably attached to the adapter plate). As discussed above, in at least one embodiment, the first set of openings pass completely through the adapter plate, while the second set of openings do not pass completely through the adapter plate.

In an exemplary but not limiting embodiment, each first fastener 82 includes a threaded shaft and a threaded retainer, and each second fastener 84 includes a threaded shaft. If desired, the adapter plate in the kit can include the previously described shelf extending away from one side of the adapter plate. Such a shelf can be used to provide support for an electric motor to be used with a fishing rod placed in the fishing rod holder bracket. In at least one embodiment, the shelf includes an opening configured to engage a threaded rod used to support the electric motor, and the kit includes the threaded rod to support the motor. In at least one embodiment, such a threaded rod includes a distal surface (planar or curved) configured to engagingly support the electric rod motor.

If desired, the adapter plate in the kit includes at least one additional opening, the additional opening being configured to accommodate retaining hardware used to secure the fishing rod to the adapter plate. In such an embodiment, the kit can include the retaining hardware, a portion of which is threaded into the at least one additional opening. Exemplary retaining hardware includes an eyebolt threaded into at least one additional opening, with a cable or line that is tied to the fishing rod. A quick release fastener may be used to enable the fishing rod to be easily released from the retaining hardware.

FIG. 11 schematically illustrates a flow chart 100 detailing exemplary steps in a method for enabling a fishing rod support bracket to be attached to a downrigger mounting plate, enabling the downrigger mounting plate to be used for non-downrigged fishing. In an optional block 102 the user removes the downrigger hardware from the downrigger mounting plate (such hardware generally includes the spool 10, boom 12, cable 14, weight 15, quick release 20, and pivoting bracket 22 discussed above). This is shown as an optional step, because many fishermen remove and store these elements when the downrigger season is over. Some fishermen may leave pivoting bracket 22 (or the equivalent from another fishing equipment vendor) in place after removing spool 10, boom 12, cable 14, weight 15, quick release 20, but the pivoting bracket will be in the way, and should be removed before the adapter plate is attached to the downrigger mounting plate.

In a block 104, the adapter plate is attached to the downrigger mounting plate, generally as discussed above. In a block 106, the fishing rod support bracket is attached to the adapter plate, also generally as discussed above.

In an optional block 108, if the adapter plate is equipped with an electric motor support, the motor support is threaded into the appropriate opening in the adapter plate, and the height of the motor support is adjusted as required. In some embodiments, the adapter plate includes a shelf configured to provide the support for the electric rod motor, while in other embodiments the motor support is introduced into an opening in the adapter plate that is not part of a shelf extending beyond the dimensions of the downrigger mounting plate (see openings 50a-50d in FIG. 8). If desired, a locking nut or other retaining can be included with the motor support (generally a threaded rod) to enable the motor support to be locked into a desired position relative to the electric rod motor.

In an optional block 110, retaining hardware is used to secure the fishing rod to the adapter plate, generally as discussed above.

FIG. 12 is a production drawing including plan and side elevational views of a first adapter 40a intended to be used for a specific downrigger mounting plate and fishing rod support bracket (the relative positions of first openings 42 and second openings 44 having been selected to accommodate a fishing rod support bracket and downrigger mounting plate available through Scotty Fishing and Marine Products (specifically, a No. 241 Combination Side or Deck Mount™ fishing rod support bracket, and a Scotty 1026 Pedestal Swivel Mount).

Details on inserts 45 for second openings 44 are shown. Also apparent in this Figure are upper portions 42a of first openings 42, configured to engage a hex headed fastener generally as discussed above. Exemplary dimension for the adapter plate and the various openings are provided.

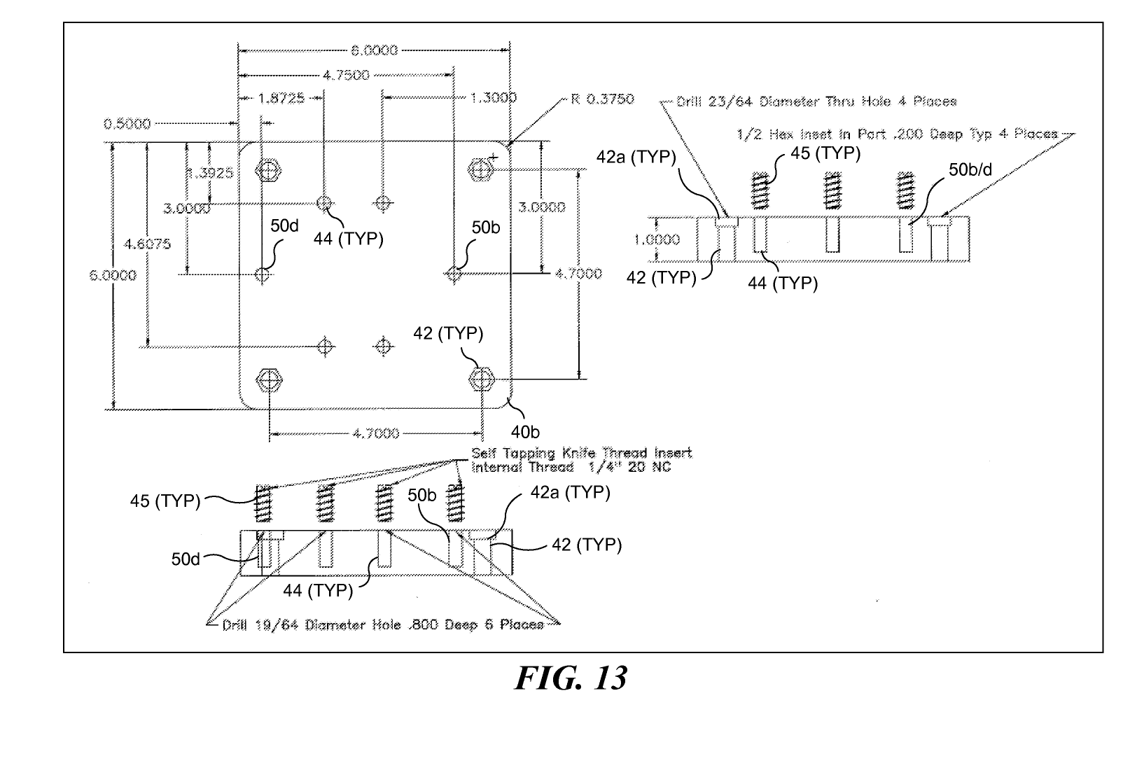

FIG. 13 is a production drawing including plan and side elevational views of a second adapter 40b intended to be used for a specific downrigger mounting plate and fishing rod support bracket. Adapter 40b is very similar to adapter 40a, but includes additional openings 50b and 50d, to enable retaining hardware to be used to secure the fishing rod to the adapter plate, generally as discussed above. In some cases, opening 50d could be used to receive an electric rod motor support, also generally discussed above, where a user employs a left handed verses right handed reel. Exemplary dimensions for the adapter plate and the various openings are provided.

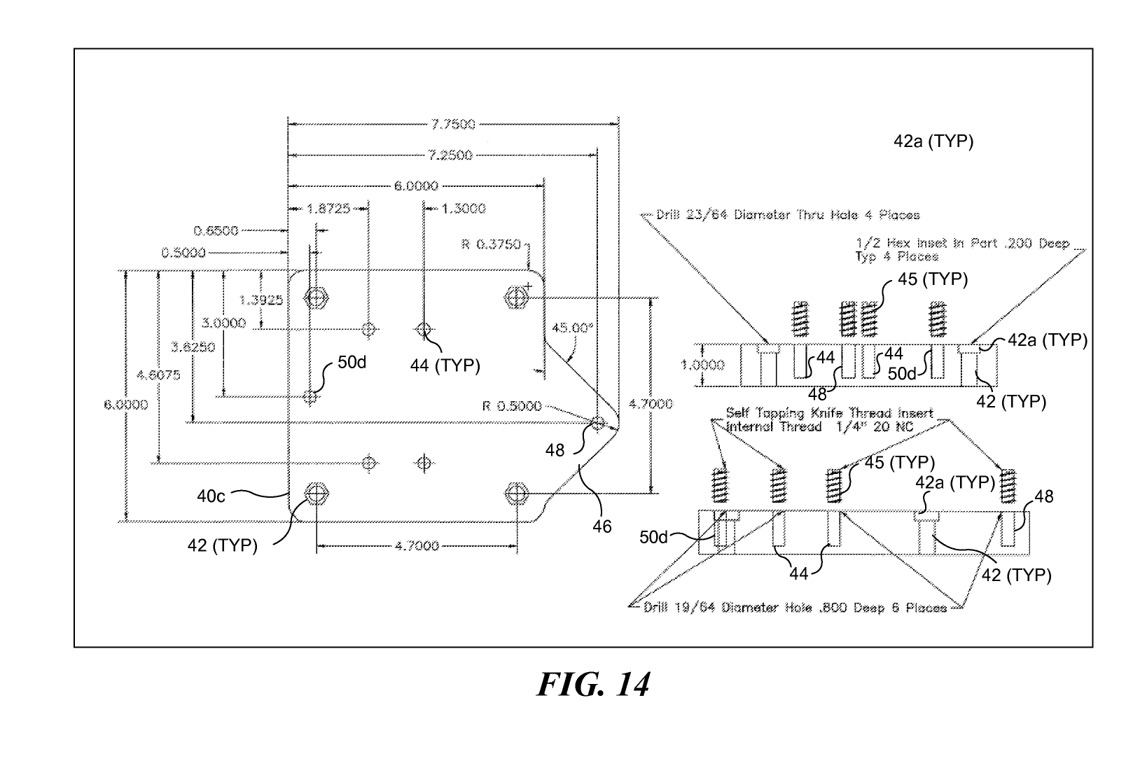

FIG. 14 is a production drawing including plan and side elevational views of a third adapter 40c intended to be used for a specific downrigger mounting plate and fishing rod support bracket, the third adapter including shelf 46 for supporting an electric rod motor, generally as discussed above. Exemplary dimensions for the adapter plate and the various openings are provided. Adapter 40c includes opening 48 for receiving electric rod motor support, to provide support for the electric rod motor. Adapter 40c includes additional opening 50d, either for receiving electric rod motor support when the right and left hand positions of the electric rod motor are reversed, or to enable fishing rod retaining hardware to be used to secure the fishing rod to the adapter.

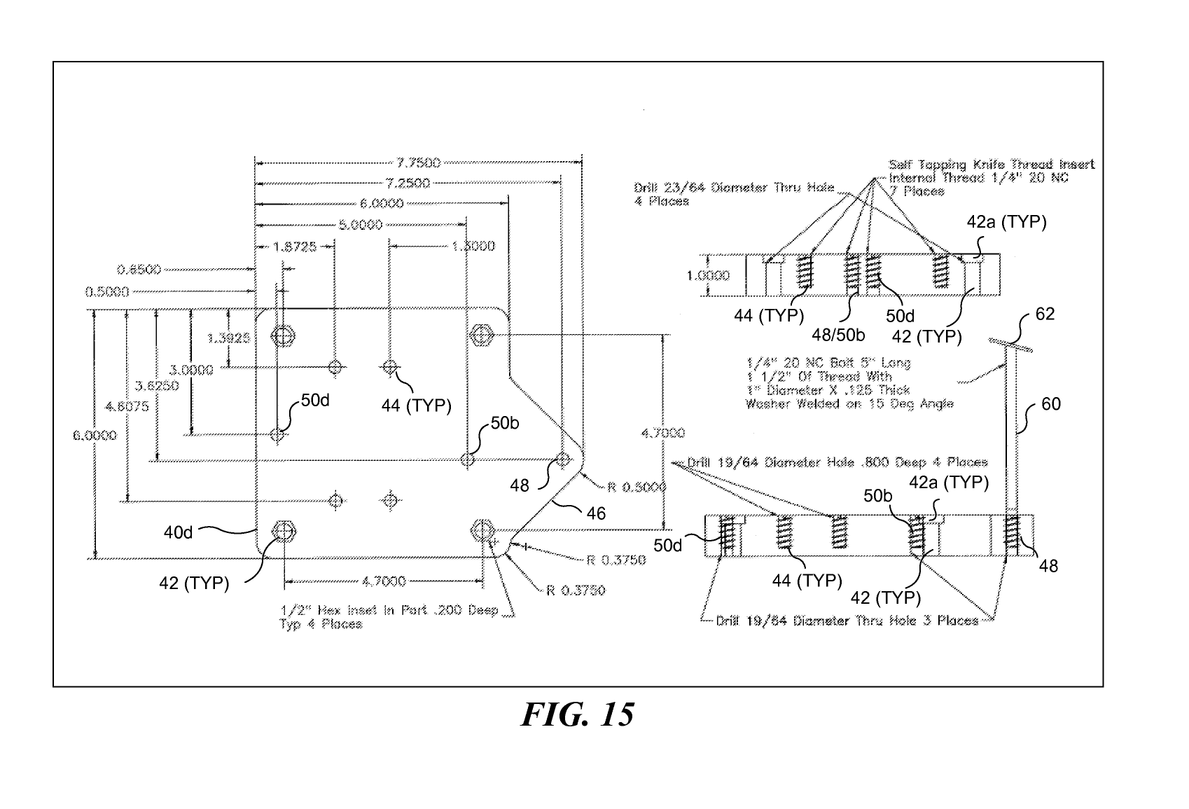

FIG. 15 is a production drawing including plan and side elevational views of a fourth adapter 40d intended to be used for a specific downrigger mounting plate and fishing rod support bracket, the fourth adapter including shelf 46 for supporting an electric rod motor, generally as discussed above. Exemplary dimensions for the adapter plate and the various openings are provided. Adapter 40d includes additional opening 50b, for receiving fishing rod retaining hardware to be used to secure the fishing rod to the adapter, generally as discussed above.

It should be understood that the relative sizes of the adapter plates disclosed herein can be modified to fit specific downrigger mounting plates provided by various fishing equipment vendors. Not only will the size and shape of the adapter plates vary, so will the relative locations of the openings for the first fasteners to attach the adapter plate to the downrigger mounting plate, and the second fasteners to attach the fishing rod support bracket to the adapter plate. The relative locations of the additional openings in the adapter plate for the fishing rod retaining hardware (to secure the fishing rod to the adapter plate) and the electric rod motor support can also be varied as required to accommodate specific fishing rods and electric rod motor configurations.

The term downrigger mounting plates, as used herein and the claims that follow, is intended to encompass structures (generally having at least one upper planar surface) that are intended to provide support for removable downrigger systems, which generally include the spools, booms, weights, and cables discussed above. Many such systems also include a structure similar to pivoting bracket 22 (see FIG. 3), although it should be recognized that the concepts disclosed herein can be used with downrigger mounting plates for use with downrigger systems that do not specifically include pivoting bracket 22. Exemplary downrigger mounting plates are shown in FIGS. 4-6. Significantly, such downrigger mounting plates include a planar upper surface upon which the downrigger hardware (the spool, cable and boom, shown in FIG. 1) can be removably secured. Thus, in an exemplary implementation, the adapter plates disclosed herein include a generally planar lower surface, to engage the upper planar surface of the downrigger mounting plate. The adapter plate will beneficially include a generally planar upper surface, upon which the fishing rod holder bracket can be attached. The term generally planar should be understood to encompass surfaces that are primarily flat, and which curve in any direction by less than about 10%. Should a particular downrigger mounting plate include any surface features varying from the generally planar upper surfaces shown in FIGS. 4-6, corresponding features could be molded into the lower face of the adapter plate, to accommodate such features.

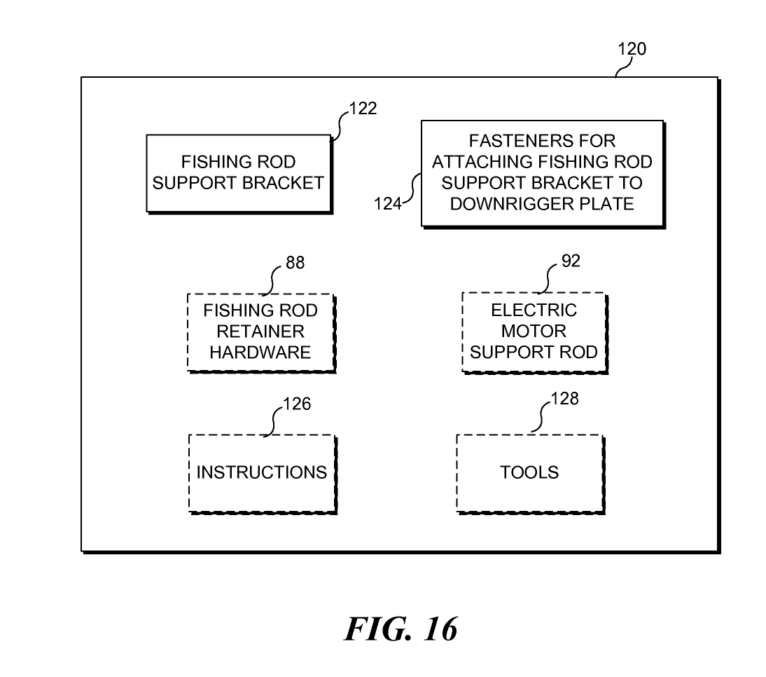

FIG. 16 schematically illustrates an exemplary kit 120 for enabling a fishing rod support bracket to be directly attached to a downrigger mounting plate, enabling the downrigger mounting plate to be used for non-downrigged fishing. In this embodiment, no adapter plate is required, because the fishing rod support bracket itself (or the downrigger mounting plate, as discussed below) is modified to include openings (into which fasteners can be introduced) that align with openings on the downrigger mounting plate. For example, as discussed above, many existing downrigger mounting plates include openings allowing downrigger hardware to be removably attached to the downrigger mounting plate. The fishing rod support bracket is either modified to include openings that align with the existing openings on the downrigger mounting plate, or the fishing rod support bracket is originally manufactured to include openings that align with the existing openings on a particular style of downrigger mounting plate. Basic elements in kit 120 include a fishing rod support bracket 122 (one example of a fishing rod support bracket is shown in FIG. 7) and fasteners 124 (for attaching the fishing rod support bracket to the downrigger mounting plate).

Optional elements fishing rod retainer hardware 88 (such as threaded rod 68, cable tie 70, and if desired a quick release fastener, generally as discussed above), and an electric rod motor support rod 92 (the function of such optional elements has been generally described in connection with FIG. 9). Note that the downrigger mounting plate will not likely include openings for fishing rod retainer hardware 88 or electric rod motor support rod 92, thus the end user may need to drill or otherwise form the required openings in the downrigger mounting plate. The kit can optionally include tools 128 (such as a drill bit and inserts to be placed into an opening to engage a threaded fastener) and directions 126 enabling the end user to modify a downrigger mounting plate to accept the optional items. Note that such directions, drill bits and inserts can also be used to introduce openings into the downrigger mounting plate that align with openings in the fishing rod support bracket, if the fishing rod support bracket and downrigger mounting plate do not include aligned openings enabling the fishing rod support bracket to be attached directly to the downrigger mounting plate. Such instructions can also provide guidance on forming openings on the fishing rod support bracket, instead of introducing such openings on the downrigger mounting plate. Such a kit (for attaching a fishing rod holder bracket to a downrigger mounting plate) enables the downrigger mounting plate to be used as a fishing rod support for non-downrigged fishing.

Although the concepts disclosed herein have been described in connection with the preferred form of practicing them and modifications thereto, those of ordinary skill in the art will understand that many other modifications can be made thereto within the scope of the claims that follow. Accordingly, it is not intended that the scope of these concepts in any way be limited by the above description, but instead be determined entirely by reference to the claims that follow.

The invention in which an exclusive right is claimed is defined by the following:

1. An adapter plate for attaching a fishing rod holder bracket to a downrigger mounting plate, enabling the downrigger mounting plate to be used as a fishing rod support for non-downrigged fishing; the adapter plate comprising:
(a) a first set of openings configured to align with existing openings on the downrigger mounting plate, the first set of openings enabling the adapter plate to be removably attached to the downrigger mounting plate, the first set of openings passing completely through the adapter plate; and
(b) a second first set of openings configured to align with existing openings on the fishing rod holder bracket, the second set of openings enabling the fishing rod holder bracket to be removably attached to the adapter plate, the second set of openings not passing completely through the adapter plate.

2. The adapter plate of claim 1, wherein the adapter plate comprises an upper surface having four corners defining a parallelogram, each corner including one of the first set of openings, and the second set of openings being disposed inwardly of the first set of openings.

3. The adapter plate of claim 1, wherein each second opening comprises a threaded insert configured to receive a threaded fastener used to secure the fishing rod holder bracket to the adapter plate.

4. The adapter plate of claim 1, wherein each first opening includes a first portion and a second portion, the first portion being relatively larger in diameter than the second portion, the first portion being in contact with an upper surface of the adapter plate, the first portion enabling a fastener inserted into each first opening to sit flush with the upper surface.

5. The adapter plate of claim 1, wherein the adapter plate comprises a shelf extending outwardly and away from one side of adapter plate, the shelf providing support for an electric motor to be used with a fishing rod placed in the fishing rod holder bracket.

6. The adapter plate of claim 5, wherein the shelf extends beyond the downrigger mounting plate, and includes an opening configured to engage a threaded rod used to support the electric motor.

7. The adapter plate of claim 1, further comprising at least one additional opening, the additional opening configured to engage retaining hardware for securing a fishing rod inserted into the fishing rod holder bracket to the adapter plate.

8. The adapter plate of claim 1, wherein the adapter plate is made from a polymeric material.

9. The adapter plate of claim 1, wherein the first and second set of openings each include four openings.

10. The adapter plate of claim 1, wherein the adapter plate is sized and shaped to cover the entire upper surface of the downrigger mounting plate when the adapter plate is secured to the downrigger mounting plate.

11. A kit for attaching a fishing rod holder bracket to a downrigger mounting plate, the kit enabling the downrigger mounting plate to be used as a fishing rod support for non-downrigged fishing; the kit comprising:
(a) an adapter plate to be attached to a downrigger mounting plate, the adapter plate comprising:
(i) a first set of openings configured to align with existing openings on the downrigger mounting plate, the first set of openings enabling the adapter plate to be removably attached to the downrigger mounting plate, the first set of openings passing completely through the adapter plate; and
(ii) a second set of openings configured to align with existing openings on the fishing rod holder bracket, the second set of openings enabling the fishing rod holder bracket to be removably attached to the adapter plate, the second set of openings not passing completely through the adapter plate;
(b) a plurality of first fasteners for attaching the adapter plate to the downrigger mounting plate, each first fastener including a threaded shaft and a threaded retainer; and
(c) a plurality of second fasteners for attaching the fishing rod holder bracket to the adapter plate, each second fastener including a threaded shaft.

12. The kit of claim 11, further including the fishing rod bracket holder.

13. The kit of claim 11, wherein the adapter plate comprises a shelf extending away from one side of the adapter plate, the shelf providing support for an electric motor to be used with a fishing rod placed in the fishing rod holder bracket.

14. The kit of claim 13, wherein the adapter plate shelf includes an opening configured to engage a threaded rod used to support the electric motor, the kit further comprising the threaded rod.

15. The kit of claim 14, wherein an upper end of the threaded rod includes an upper surface configured to engagingly support the electric motor.

16. The kit of claim 11, wherein:
(a) each first opening includes a first portion and a second portion, the first portion being relatively larger in diameter than the second portion, the first portion being in contact with an upper surface of the adapter plate, the first portion enabling a fastener inserted into each first opening to sit flush with the upper surface; and
(b) each second opening comprises a threaded insert configured to receive a threaded fastener used to secure the fishing rod holder bracket to the adapter plate.

17. The kit of claim 11, further comprising retaining hardware for securing a fishing rod inserted into the fishing rod holder bracket to the adapter plate.

18. A method of enabling a downrigger mounting plate to be used as a fishing rod support for non-downrigged fishing, the method comprising the steps of:
(a) attaching an adapter plate to the downrigger mounting plate, in place of a downrigger spool and boom structure normally attached to the downrigger mounting plate; and
(b) attaching a fishing rod support bracket to the adapter plate, thereby enabling the downrigger mounting plate to be used as a fishing rod support for non-downrigged fishing.

19. The method of claim 18, wherein the step of attaching the adapter plate comprises the step of attaching an adapter plate comprising:
(a) a first set of openings configured to align with existing openings on the downrigger mounting plate, the first set of openings enabling the adapter plate to be removably attached to the downrigger mounting plate, the first set of openings passing completely through the adapter plate; and
(b) a second set of openings configured to align with existing openings on the fishing rod holder bracket, the second set of openings enabling the fishing rod holder bracket to be removably attached to the adapter plate, the second set of openings not passing completely through the adapter plate.

20. The method of claim 18, wherein the step of attaching the adapter plate comprises the step of attaching an adapter plate comprising a shelf extending beyond the downrigger mounting plate, the shelf providing support for an electric motor to be used with a fishing rod placed in the fishing rod holder bracket.

21. The method of claim 20, further comprising the step of inserting a threaded rod into an opening in the shelf, the threaded rod having a planar surface on its distal end, and adjusting a height of the threaded rod such that the planar surface provides support to the electric motor.

22. The method of claim 18, further comprising the step of using retaining hardware for securing a fishing rod inserted into the fishing rod holder bracket to the adapter plate.

23. A kit for attaching a fishing rod holder bracket to a downrigger mounting plate, the kit enabling the downrigger mounting plate to be used as a fishing rod support for non-downrigged fishing; the kit comprising:
(a) a fishing rod holder bracket comprising:
(i) a first set of openings configured to align with existing openings on the downrigger mounting plate, the first set of openings enabling the fishing rod holder bracket to be removably attached to the downrigger mounting plate, the first set of openings passing completely through the fishing rod holder bracket; and
(ii) at least one relatively larger opening configured to supportably engage a fishing rod; and
(b) a plurality of first fasteners for attaching the fishing rod holder bracket to the downrigger mounting plate, each first fastener including a threaded shaft.
